(19) United States
(12) Patent Application Publication
(10) Pub. No.: US 2007/0008107 A1
(43) Pub. Date: Jan. 11, 2007

(54) Method and apparatus for monitoring mobile containers

(75) Inventors: Steven J. Farrell, Sunnyvale, CA (US); Blair B. LaCorte, Belvedere, CA (US); Ravindra U. Rajapakse, San Francisco, CA (US)

Correspondence Address: HAYNES AND BOONE, LLP, 901 MAIN STREET, SUITE 3100, DALLAS, TX, 75202, US

(73) Assignee: Savi Technology, Inc., Sunnyvale, CA (US)

(21) Appl. No.: 11/158,300

(22) Filed: Jun. 21, 2005

(51) Int. Cl. G08B 1/08

(52) U.S. Cl. 340/539.1

(57) ABSTRACT

An apparatus includes a monitoring system having first and second portions adapted to be supported on a mobile arrangement that includes a container. The first portion has structure for monitoring a selected aspect of the container, and for transmitting from the first portion to the second portion a first wireless communication that includes first information relating to the selected aspect. The second portion has structure for broadcasting from the second portion to a remote location a second wireless communication that includes second information based on the first information.

### FIELD OF THE INVENTION

This invention relates in general to mobile containers and, more particularly, to techniques for monitoring mobile containers.

### BACKGROUND

Many different types of mobile containers are used for transporting and shipping a wide variety of items. One example of a mobile container is a truck with an enclosed portion that serves as the container. Persons assisting with the transport of a mobile container, such as the driver of a truck, are not always trusted agents.

Accordingly, there are situations where it is desirable to be able to generate prompt notice if tampering occurs while a mobile container is in transit. As one example, a truck or some other mobile container may be transporting an authorized shipment of military weapons. Given the global threat of terrorism, it is desirable that notice be promptly provided to a central location if there is any tampering and/or theft in regard to the container or its cargo.

### SUMMARY OF THE INVENTION

One of the broader forms of the invention involves: supporting first and second portions of a monitoring system on a mobile arrangement that includes a container; monitoring a selected aspect of the container with the first portion; transmitting a first wireless communication from the first portion to the second portion, the first wireless communication including first information relating to the selected aspect of the container; and broadcasting a second wireless communication from the second portion to a remote location, the second wireless communication including second information that is based on the first information.

### BRIEF DESCRIPTION OF THE DRAWINGS

A better understanding of the present invention will be realized from the detailed description that follows, taken in conjunction with the accompanying drawings, in which:

FIG. 1 is a diagrammatic side view of an apparatus having a satellite, a truck that serves as a mobile arrangement, and a monitoring system that includes two antennas mounted on the truck.

FIG. 2 is a diagrammatic side view of the satellite and part of the truck of FIG. 1, in an enlarged scale.

FIG. 3 is a diagrammatic rear view showing a trailer that is part of the truck, along with several radio frequency identification tags that are mounted on the trailer.

FIG. 4 is a diagrammatic fragmentary rear view showing a portion of FIG. 3 in a substantially enlarged scale.

FIG. 5 is a diagrammatic fragmentary sectional top view taken along the section line 5-5 in FIG. 4.

FIG. 6 is a diagrammatic fragmentary perspective view of one of the tags and part of the trailer, in a substantially enlarged scale.

### DETAILED DESCRIPTION

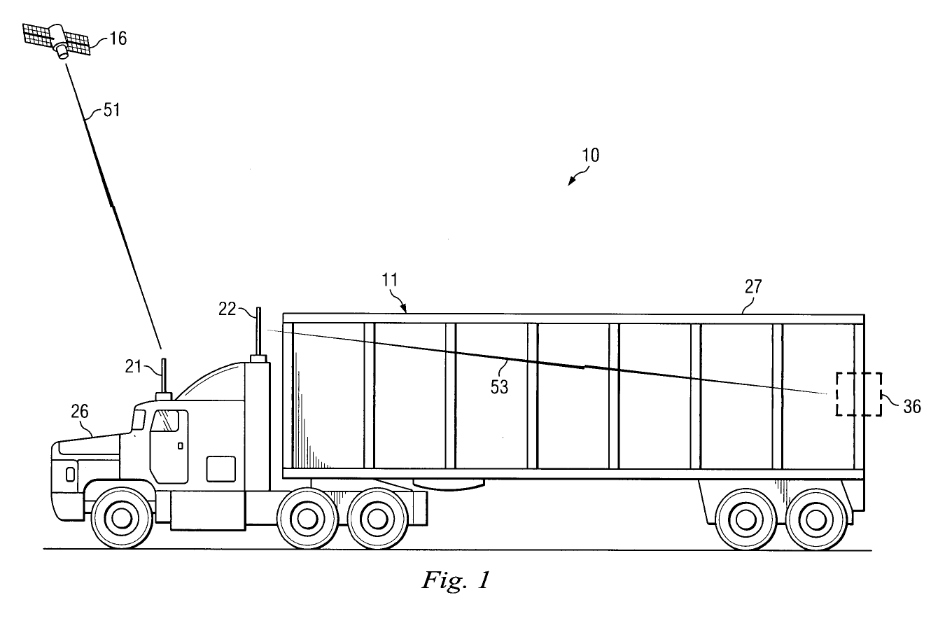

FIG. 1 is a diagrammatic side view of an apparatus 10, the apparatus 10 having a satellite 16, a truck 11 that serves as a mobile arrangement, and a monitoring system that includes antennas 21 and 22 mounted on the truck 11. In the disclosed embodiment, the truck 11 is a tractor-trailer combination of a known type, and in particular includes a tractor 26 and a trailer 27 that are pivotally coupled to each other. The trailer 27 includes an enclosed portion that serves as a container for items that are being transported by the truck 11. Although the mobile arrangement in the disclosed embodiment is a truck 11, it would alternatively be possible to use some other form of mobile arrangement.

In addition to the antennas 21 and 22, the monitoring system has other structure that is not visible in FIG. 1. For example, the monitoring system includes one or more radio frequency identification (RFID) tags that are mounted on the trailer 27 within a region 36 at the rear end thereof. These RFID tags are discussed in more detail later. Although the disclosed embodiment has these tags located in the region 36, they could alternatively be positioned at any other desired location on the truck 11.

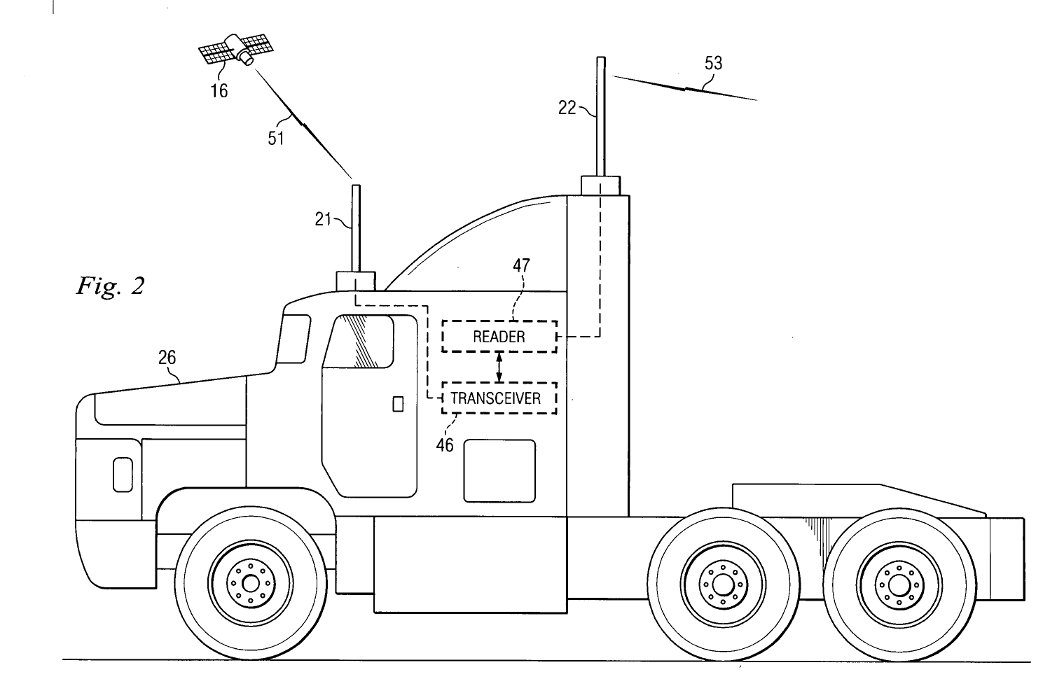

FIG. 2 is a diagrammatic side view of the satellite 16 and the tractor 26 of FIG. 1, in an enlarged scale. The antenna 21 of the monitoring system is fixedly mounted on top of a cab of the tractor 26, so as to be approximately centered between the sides of the cab. Turning to the antenna 22, only one antenna 22 is visible in FIGS. 1 and 2, but the monitoring system actually includes two of the antennas 22. More specifically, the two antennas 22 are fixedly mounted at laterally spaced locations on top of the cab of the tractor 26, with each antenna 22 disposed near a respective side of the cab. Thus, one of the antennas 22 is visible in FIGS. 1 and 2, and the other is behind it.

In the disclosed embodiment, the antennas 21 and 22 are mounted on top of the cab of the tractor 26. However, it would alternatively be possible to mount the antennas at any other suitable location on the truck 11. For example, the two antennas 22 could each be mounted on a respective front fender of the tractor 26, or on a respective side mirror thereof. As another alternative, some or all of the external antennas 21 and 22 could be replaced with internal antennas disposed within the cab of the tractor 26.

In addition to the antennas 21 and 22, the monitoring system includes a transceiver 46 and a reader 47 that are disposed within the cab of the tractor 26. The transceiver 46 is operatively coupled to the antenna 21. The transceiver 46 uses the antenna 21 to transmit wireless signals to the satellite 16, and to receive wireless signals from the satellite 16, as indicated diagrammatically at 51. Although the disclosed embodiment has the transceiver 46 and the antenna 21 configured to communicate with the satellite 16, it would alternatively be possible for the transceiver 46 and antenna 21 to be configured for wireless communication with some other type of system, such as a cellular telephone network. Further, the transceiver 46 could include a global positioning system (GPS) device that receives GPS signals from GPS satellites, and that calculates the location of the apparatus 10. The GPS device would then supply the location information to the transceiver 46, which in turn can include this location information in the wireless signals 51.

The reader 47 is an RFID reader of a known type. With reference to FIGS. 1 and 2, the reader 47 is coupled to each of the antennas 22, and uses them to transmit wireless signals to and receive wireless signals from the tags within the region 36, as indicated diagrammatically at 53.

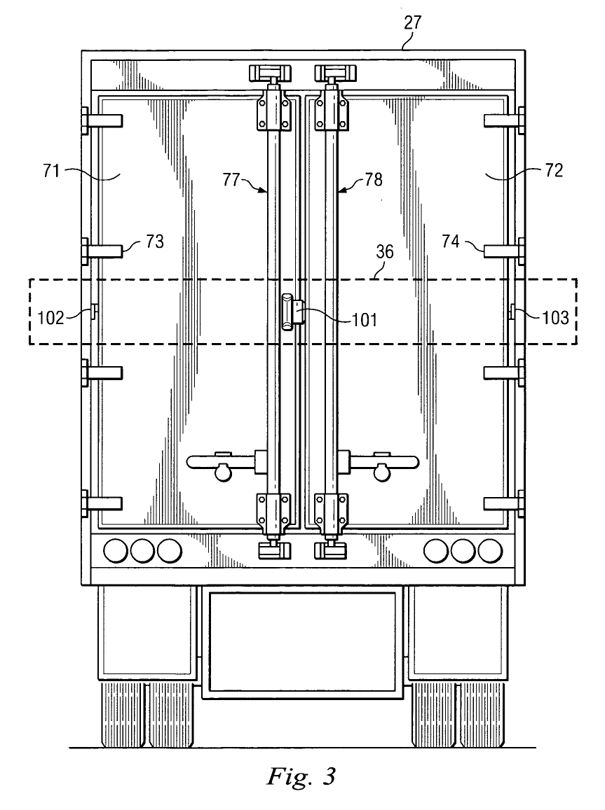

FIG. 3 is a diagrammatic rear view of the truck 11 of FIG. 1, and in particular shows the rear of the trailer 27. The trailer 27 includes two doors 71 and 72 that are each supported for pivotal movement about a respective vertical axis by several hinges, two of the hinges being identified by reference numerals 73 and 74. In FIG. 3, the doors 71 and 72 are each shown in a closed position, and can each be pivoted outwardly from this closed position to an open position that is not shown in the drawings. Each of the doors 71 and 72 can be releasably locked in its closed position by a respective locking mechanism 77 or 78.

As mentioned above in association with FIG. 1, the monitoring system includes a plurality of RFID tags that are disposed within the region 36. FIG. 3 shows that, in the disclosed embodiment, the monitoring system has three RFID tags 101, 102 and 103 that are disposed within the region 36. The tags 101-103 are devices of a type that is known in the art. They are therefore described only briefly below, to an extent that facilitates an understanding of the present invention.

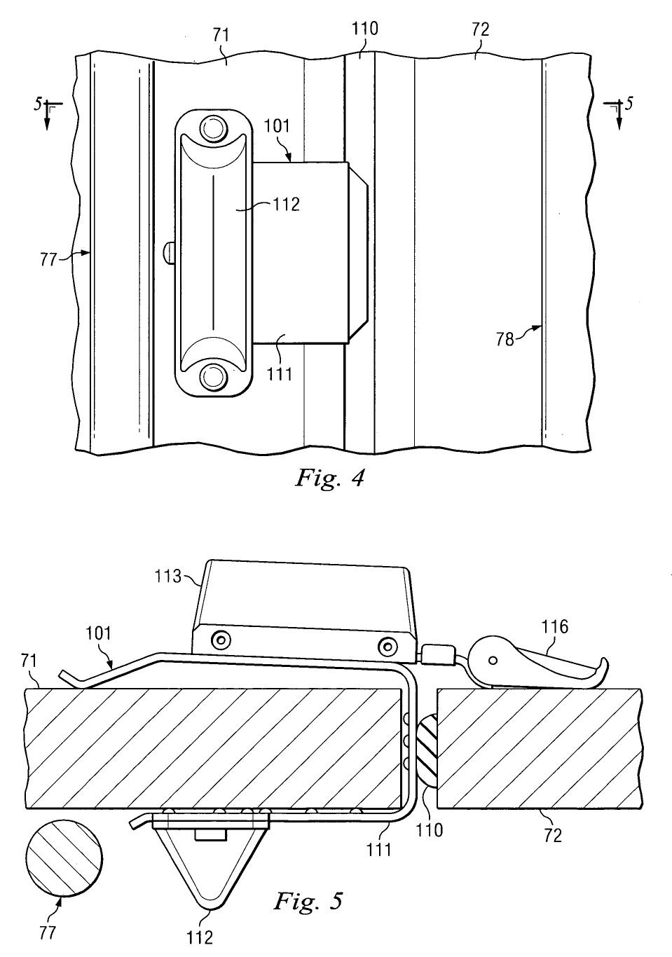

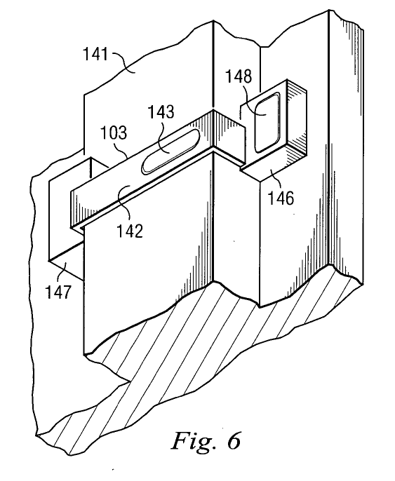

In this regard, FIG. 4 is a diagrammatic fragmentary rear view showing a portion of FIG. 3 in a substantially enlarged scale, including the tag 101. FIG. 5 is a diagrammatic fragmentary sectional top view taken along the section line 5-5 in FIG. 4. As best seen in FIG. 5, the tag 101 includes a C-shaped clamp 111 that grips an edge portion of the door 71. In particular, the clamp 111 has two spaced legs that are disposed on opposite sides of the door 71, and has a bight that extends from one leg to the other through a gap between the doors 71 and 72. A flexible weather seal 110 made of rubber or a similar material is disposed on the inner edge of the door 72, and engages the bight of the clamp 11.

The tag 101 has a housing 112 on the outer leg of the clamp 111. The housing 112 contains a not-illustrated antenna, through which the tag 101 can send and receive wireless signals. The tag 101 has a further housing 113 disposed on the inner leg of the clamp 111. The housing 113 contains not-illustrated circuitry that is coupled by not-illustrated wires to the antenna within the housing 112. The circuitry includes not-illustrated sensors that monitor various characteristics within the container portion of the trailer 27. In the disclosed embodiment, these sensors include a temperature sensor and a humidity sensor, and also a photocell that can detect visible light. A door engaging part 116 is pivotally supported on the housing 113, and is biased by a spring to engage the inner side of the door 72 when the doors 71 and 72 are in their closed positions. If the door 72 is opened, the part 116 will be moved by the spring, and the circuitry within the housing 113 will detect this movement. In addition to or in place of the sensors discussed above, the tag 101 could have a pressure sensor, a moisture sensor, a radiation sensor for detecting radioactive emissions, a gas sensor for detecting hazardous or poisonous gases (such as hydrogen cyanide or phosgene), an RF sensor that can monitor an RF signal for changes indicative of unauthorized intrusion, or any other desired type of sensor.

From the foregoing discussion, it will be recognized that are different ways in which the circuitry within the housing 113 can detect a situation where either of the doors 71 and 72 is opened. For example, the circuitry can detect visible light that enters when either door is open, and can detect movement of the part 116 when a door opens. The circuitry can then use the antenna within the housing 112 to transmit a wireless signal that indicates one or both of the doors 71 and 72 have been opened. The circuitry within the housing 113 can also detect a condition where the temperature or humidity within the container portion of the trailer 27 is above or below a selected limit, and can transmit a wireless signal identifying the particular condition that has been detected.

In the disclosed embodiment, the tags 102 and 103 are effectively identical. Therefore, to avoid redundancy, only the tag 103 is discussed here. FIG. 6 is a diagrammatic fragmentary perspective view of the tag 103 and part of the trailer 27, in a substantially enlarged scale. The trailer 27 has a door frame 141, and the tag 103 has a C-shaped clamp 142 that grips the door frame 141. In particular, the C-shaped clamp 142 has two spaced legs that are coupled by a bight 142. A pressure switch 143 is provided on the bight 142. When the door 72 (FIG. 3) is in its closed position, an edge of the door engages and activates the pressure switch 143, so that the tag 103 knows the door 72 is in its closed position. The tag 103 has two housings 146 and 147 that are provided at the outer ends of the respective legs of the clamp 142. The housing 146 has a patch antenna 148 on an exterior surface thereof. The housing 147 contains electronic circuitry of the tag 103, including several sensors such as a temperature sensor, a humidity sensor, a photocell and/or some other type of sensor. The circuitry within the housing 148 is electrically coupled by not-illustrated wires to the pressure switch 143 and the antenna 148.

The operation of the tag 103 is generally similar to the operation of the tag 101. Therefore, since the operation of the tag 101 has already been briefly described above, the operation of the tag 103 is not separately described here in detail.

When the truck 11 of FIG. 1 is in transit, the monitoring system operates in the following manner. The reader 47 periodically transmits a wireless interrogation signal 53 through the two antennas 22, for example at points in time that are separated by intervals of N seconds. Any RFID tags that are present on the truck 11 will respond to this interrogation signal, including the tags 101, 102 and 103. Each such tag will transmit back at 53 a wireless response that contains certain status information, as well as a code that uniquely identifies that particular tag. The status information will indicate whether the tag has detected any problem regarding any of the various different aspects of the container that the tag is monitoring.

For example, each of the tags 101-103 will indicate whether it detected that a door 71 or 72 of the trailer has been opened, whether it detected an abnormal temperature condition, whether it detected an abnormal humidity condition, and so forth. Consequently, if there has been an unauthorized entry into the trailer 27, at least one of the tags 101-103 will be reporting information that reflects this. In addition, the tags 101-103 each have a degree of capability to detect a situation where someone tampers with the tag itself. Consequently, if any of the tags 101-103 determines that someone tampered with it, the tag will report this in one of the wireless signals 53 that it sends to the reader 47.

The two spaced antennas 22 help to reduce the likelihood that a wireless signal traveling in either direction between the reader 47 and the tags 101-103 will not be properly received. For example, the tag 102 is on one side of the truck 11, and may communicate more readily with the antenna 22 on the same side of the truck than with the other antenna 22. Similarly, the tag 103 is located on the opposite side of the truck 11, and may communicate more readily with the antenna 22 on the same side of the truck than with the other antenna 22. Further, the tag 101 is centered in the back of the truck 11, and use of the two spaced antennas 22 may facilitate the transmission of wireless communications to and from the tag 101, for example when the truck is turning a corner.

As explained above, the tags 101-103 receive and then reply to a periodic wireless interrogation signal sent by the reader 47. In addition, if any of the tags 101-103 detects an abnormal event, the tag immediately transmits a wireless signal that contains the unique code of the tag and that identifies the event, without waiting for the next interrogation signal. Later, when the next interrogation signal is received, the tag will send a reply that identifies the detected event.

The reader 47 takes the information received from the tags 101-103, and uses the transceiver 46 and the antenna 21 to transmit wireless signals 51 containing this information to a location remote from the truck 11, and in particular to the satellite 16. The satellite 16 then transmits a wireless signal that relays this information to a central system at some other location remote from the truck 11. The central system will then be aware of whether or not everything is normal with the truck 11, and in particular will know if some abnormal event has been detected by the monitoring system on the truck 11.

As a further possibility, items being transported in the trailer 27 may have not-illustrated RFID tags thereon that transmit wireless signals, and one or more of the tags 101-103 may have the capability to receive these wireless signals. After these wireless signals are received by one or more of the tags 101, 102 or 103, the information can be used to generate inventory information or a manifest list that identifies the items present in the trailer 27. In one approach, the tag 101, 102 or 103 generates the inventory information, and can save that information in its own memory and/or pass the information on to the central system through the wireless signals 51 and the satellite 16. Where the inventory information is passed on to the central system, the tag may maintain a duplicate copy of that information in its memory, or may maintain only an identifier that can be used to look up the inventory information in a database of the central system. In the latter case, a person would need not only the identifier but also an authenticated link to the central system in order to access the inventory information stored in the central system.

Although one selected embodiment has been illustrated and described in detail, it should be understood that a variety of substitutions and alterations are possible without departing from the spirit and scope of the present invention, as defined by the following claims.

What is claimed is:

1. A method comprising:
supporting first and second portions of a monitoring system on a mobile arrangement that includes a container;
monitoring a selected aspect of the container with said first portion;
transmitting a first wireless communication from said first portion to said second portion, said first wireless communication including first information relating to the selected aspect of the container; and
broadcasting a second wireless communication from said second portion to a remote location, said second wireless communication including second information that is based on said first information.

2. A method according to claim 1, including configuring said first portion to include a radio frequency identification tag.

3. A method according to claim 1, including configuring said second portion to include a radio frequency identification reader.

4. A method according to claim 1, including configuring said second portion to include a transmitter that transmits said second wireless communication as one of a satellite signal and a cellular signal.

5. A method according to claim 1, wherein said monitoring includes monitoring whether a door of the container is moved away from a closed position.

6. A method according to claim 1, including periodically transmitting a wireless interrogation communication from said second portion to said first portion, said transmitting of said first wireless communication being carried out in response to receipt by said first portion of said wireless interrogation communication.

7. A method according to claim 1, including:
configuring said monitoring system to include a third portion supported on the mobile arrangement;
monitoring a further aspect of the container with said third portion;
transmitting a third wireless communication from said third portion to said second portion, said third wireless communication including third information relating to the further aspect of the container; and
broadcasting a fourth wireless communication from said second portion to a remote location, said fourth wireless communication including fourth information that is based on said third information.

8. A method according to claim 1, including configuring said second portion to have two spaced antennas that are each capable of receiving said first wireless communication.

9. A method according to claim 1, including:
transmitting a third wireless communication from said first portion to said second portion, said third wireless communication including third information relating to an aspect of said first portion; and
broadcasting a fourth wireless communication from said second portion to a remote location, said fourth wireless communication including fourth information that is based on said third information.

10. A method according to claim 9, including configuring said first portion to have structure for detecting tampering with said first portion, said third information including an indication that tampering with said first portion has been detected.

11. A method according to claim 1, including configuring said first portion to have structure for detecting an environmental condition within said container, said first information including information relating to said environmental condition.

12. A method according to claim 1, including:
receiving GPS signals in said second portion;
deriving location information from said GPS signals; and
configuring said second information to include said location information.

13. A method according to claim 1, including: configuring said first portion to receive wireless signals from tags on items within said container; and
configuring said first information to include inventory information derived from said wireless signals.

14. A method according to claim 1, including:
providing a truck that serves as the mobile arrangement and that has a tractor and a trailer operatively coupled to each other, the container being part of the trailer; and
carrying out said supporting so that said first portion is on said trailer and said second portion is on said tractor.

15. An apparatus comprising a monitoring system having first and second portions adapted to be supported on a mobile arrangement that includes a container, said first portion having structure for monitoring a selected aspect of the container and for transmitting from said first portion to said second portion a first wireless communication that includes first information relating to the selected aspect, and said second portion having structure for broadcasting from said second portion to a remote location a second wireless communication that includes second information which is based on said first information.

16. An apparatus according to claim 15, wherein said structure of said first portion includes a radio frequency identification tag.

17. An apparatus according to claim 15, wherein said structure of said second portion includes a radio frequency identification reader.

18. An apparatus according to claim 15, wherein said structure of said second portion includes a transmitter that transmits said second wireless communication as one of a satellite signal and a cellular signal.

19. An apparatus according to claim 15, wherein said structure of said first portion for monitoring said selected aspect includes structure for monitoring whether a door of the container moves away from a closed position.

20. An apparatus according to claim 15,
wherein said second portion periodically transmits a wireless interrogation communication to said first portion; and
wherein said structure of said first portion is responsive to receipt of said wireless interrogation communication for effecting said transmitting of said first wireless communication.

21. An apparatus according to claim 15, wherein said monitoring system has a third portion adapted to be supported on the mobile arrangement, said third portion having structure for monitoring a further aspect of the container and for transmitting from said third portion to said second portion a third wireless communication that includes third information relating to the further aspect, and said second portion having structure for broadcasting from said second portion to a remote location a fourth wireless communication that includes fourth information which is based on said third information.

22. An apparatus according to claim 15, wherein said second portion has two spaced antennas that are each capable of receiving said first wireless communication.

23. An apparatus according to claim 15,
wherein said structure of said first portion transmits a third wireless communication from said first portion to said second portion, said third wireless communication including third information relating to an aspect of said first portion; and
wherein said structure of said second portion broadcasts a fourth wireless communication from said second portion to a remote location, said fourth wireless communication including fourth information that is based on said third information.

24. An apparatus according to claim 23, wherein said first portion has structure for detecting tampering with said first portion, said third information including an indication that tampering with said first portion has been detected.

25. An apparatus according to claim 15, wherein said first portion has structure for detecting an environmental condition within said container, said first information including information relating to said environmental condition.

26. An apparatus according to claim 15, wherein said second portion includes structure that receives GPS signals and derives location information therefrom, and that configures said second information to include said location information.

27. An apparatus according to claim 15, wherein said first portion includes structure for receiving wireless signals from tags on items within said container, said first information including inventory information derived from said wireless signals.

28. An apparatus according to claim 15,
including a truck having a tractor and a trailer that are operatively coupled to each other, said truck serving as the mobile arrangement, and said trailer having a container that serves as the container of the mobile arrangement; and
wherein said first portion is supported on said trailer and said second portion is supported on said tractor.
